(19) United States
(12) Patent Application Publication
(10) Pub. No.: US 2006/0025541 A1
(43) Pub. Date: Feb. 2, 2006

(54) Injection moulding resin

(75) Inventors: Philippe Bourgoin, Pully (CH); Ralf` Wiedemann, Ludwigshafen (DE)

Correspondence Address: NORRIS, MCLAUGHLIN & MARCUS, 875 THIRD AVE, 18TH FLOOR, NEW YORK, NY, 10022, US

(73) Assignee: Reckitt Benckiser N.V., Hoofddorp (NL)

(21) Appl. No.: 10/526,030

(22) PCT Filed: Aug. 26, 2003
(86) PCT No.: PCT/GB03/03689

§ 371 Date: Sep. 27, 2005

(30) Foreign Application Priority Data
Sep. 2, 2002 (GB) 0220269.5

(51) Int. Cl. C08G 63/91

(52) U.S. Cl. 525/414

(57) ABSTRACT

An article comprising a skin formed from a water soluble resin, wherein the resin comprises a water-soluble polymer and a water-soluble filler.

The present invention is related to extrudable resins suitable for injection moulding, particularly to articles comprising a skin formed from a water soluble resin, comprising a water soluble polymer and a water soluble filler material.

Water soluble packages comprising an agent to be dispensed in an aqueous medium are well known. Polyvinyl alcohol (PVOH) is known as a water-soluble packaging material. Examples of such containers comprising PVOH as a packaging material include detergent pouch packages suitable for automatic dishwashers and washing machines. CA-A-1,112,534 discloses a packet made of a water-soluble material in film form enclosing within it a paste of, automatic dishwasher-compatible detergent composition.

A common way to make a PVOH container for detergent packaging is thermo-forming the PVOH into a film. Thermo-forming is particularly suitable in this application as the films produced in this way are thin (having a thickness of around 0.1 mm). The thin nature of the film helps to prevent the development of film residues in the dishwasher/washing machine. This can arise as PVOH films do not exhibit particularly high solubility in water and can collect as a residue (often as an amalgamated lump) in a dishwasher/washing machine. Residue formation is especially an issue with detergents containing borate as borate salts complex with PVOH forming an insoluble residue. The thinner the film the lower the amount of film material that is used and hence the lower the chance of residue formation.

Packages made by the thermo-forming route have a number of disadvantages associated therewith. These disadvantages include low aesthetic appeal (due to sharp/untidy edges where the films are sealed) and poor control of the release profile of the composition held in the package. Additionally, packages made by the thermo-forming route cannot easily be produced at a commercially acceptable rate.

The use of injection moulding techniques obviates these disadvantages.

However, with containers formed by injection moulding residue formation is more of a problem because the injection moulded containers tend to have thicker skin, often more than 5 times thicker than films which have been thermo-formed. Thus the problem of residue formation is exacerbated. Also as the skin is thicker, the time taken for the containers to dissolve/liberate their contents becomes unacceptably high.

Additionally containers for detergent packaging formed by injection moulding have been found to display poor stability with caustic materials which can be found in detergents. It is considered that this arises because the choice of polymer materials useful for injection moulding is more limited than that for thermo-forming. Most polymers suitable for extrusion, a common process step with injection moulding, are homopolymers, such as PVOH. Typically homopolymers, (especially PVOH and derivatives thereof) are not only more sensitive to caustic materials but also suffer from the drawback that their solubility is reduced upon storage.

Furthermore in order for the resin material to be able to be processed by injection moulding, additives are typically required to improve the mechanical properties of the resin material. Such additives can comprise fillers like calcium or titanium salts, which not only detrimentally affect the solubility of the packaging material but can also detrimentally affect the typically transparent nature of the film (i.e. by increasing its opacity) and thus reduce the appeal of the whole package to a consumer.

It is an object of the present invention to obviate/mitigate these problems

According to a first aspect of the present invention there is provided an article comprising a skin formed from a water soluble resin moulding, wherein the resin comprises a water-soluble polymer and a water-soluble filler.

We have found that the resin may easily be processed in an injection moulding machine and formed into articles suitable for containing an active composition which is intended to be dispensed in an aqueous environment, for example a detergent composition which may be used in a dishwasher/washing machine.

The skin is most preferably rigid.

When used as a material for the formation of a water soluble/dispersible article the water soluble resin has been found to be particularly suitable, specifically by displaying a very short dissolution/dispersion time and also by producing a low amount of residue in use. Without wishing to be bound by theory it is proposed that this suitability arises as once injection moulded, it will be appreciated that the resin is not homogenous but instead is a heterogeneous admixture of components. Said admixture may, for example, take the form of a matrix of water soluble polymer with particles of water soluble filler distributed therein (alternatively the roles of the two components in the matrix may be reversed). On contact with an aqueous liquor due to relative differences in the solubility between the matrix forming component and the in-matrix component solubility is aided. Namely if the in-matrix component dissolves most rapidly the surface area of the remaining resin exposed to the liquor is significantly increased due to the presence of voids created by the removal of the in-matrix component. Similarly if the matrix forming component dissolves most rapidly, small particles of the in-matrix component, having a large surface area, are released into the aqueous liquor.

The enhanced dispersion also reduces residue formation as, in use, the resin quickly becomes highly dispersed. This has been found to be particularly appropriate at the present time as household laundry/dishwasher manufacturers are reducing the amount of water used by domestic machines as a result of environmental factors.

The water soluble filler may be selected such that it is hygroscopic, i.e. it has an attraction to water. It is recognised that the inclusion of minor amounts of water in packaging material has a beneficial influence on the stability of a container formed thereof. This water incorporation may thus be achieved simply by action of the filler material.

Additionally the resin used in the present invention obviates the cost issues associated with resins of the prior art, which are costly because of a very high polymer content necessary to achieve the desired solubility of the final shaped bodies. Surprisingly, the use of water soluble fillers in the present invention is an effective way of reducing the cost of such injection moulding resin whilst maintaining/improving the desirable high solubility properties and extrusion/article forming properties.

When referring to the polymer and the filler, water-soluble is herein defined when greater than 99% of such material (about 2 g in granular form having a particle size from 50-200 μm) dissolves within 15 minutes in a beaker containing 1 L of de-ionised water at 40° C. which is stirred with a stirrer revolving at 200 r.p.m.

When referring to the resin composition water-soluble is herein defined when greater than 90% of such material (about 2 g in granular form having a particle size from 50-200 μm) dissolves within 15 minutes in a beaker containing 1 L of de-ionised water at 40° C. which is stirred with a stirrer revolving at 200 r.p.m.

Alternatively when referring to the resin composition water-soluble may be defined with reference to a typical detergent container. Such a container may have external dimensions of the order of 30 mm×30 mm×20 mm and a wall thickness of around 1 mm. Additionally one or more internal walls may be present. Thus the container may comprise around 3-5 cm³ of packaging material.

Such a container formed from a resin of the present invention, when added to a beaker containing 1 L of de-ionised water which is stirred with a stirrer revolving at 200 r.p.m, dissipates completely at 40° C. within 20 minutes and dissipates completely at 20° C. within 30 minutes.

The water soluble polymer preferably comprises 20-90 wt % of the resin, more preferably from 25-85 wt %, more preferably from 30-80 wt %, more preferably from 35-80 wt % more preferably from 40-80 wt %, more preferably from 45-80 wt % and most preferably from 50-80 wt %.

The water soluble polymer is preferably a film forming polymer.

It will be appreciated that the water soluble polymer may comprise a homopolymer or a co-polymer. Where the water soluble polymer comprises a co-polymer the co-polymer may be a random or block co-polymer.

The water soluble polymer may comprise polyvinyl alcohol, polyvinyl pyrrolidone, partially hydrolysed polyvinyl acetate, polyvinyl acetate, a cellulose polymer (such as a cellulose ether e.g. hydroxypropyl cellulose), a copolymer (of one or more of the preceding compounds)/a derivative (such as an ester) thereof or a mixture thereof. Most preferred are copolymers of polyvinylalcohol.

The water soluble polymer preferably has dispersant, anti-redeposition, soil releasing or other detergency properties. Examples of such compounds include the water soluble homo- or co-polymeric polycarboxylic acids, modified polycarboxylates or their salts in which the polycarboxylic acid comprises at least two carboxyl radicals separated from each other by not more than two carbon atoms. Examples of such salts are polyacrylates of molecular weight from 500 to 200,000, more preferably from 1,000 to 100,000 and their copolymers with any suitable other monomer units including modified acrylic, fumaric, maleic, itaconic, aconitic, mesaconic, citraconic and methylenemalonic acid or their salts, maleic anhydride, acrylamide, alkylene, vinylmethyl ether, styrene and any mixtures thereof. Preferred are the copolymers of acrylic acid and maleic anhydride having a molecular weight of from 20,000 to 100,000. Preferred commercially available acrylic acid containing polymers having a molecular weight below 15,000 include those sold under the tradename Sokalan PA30, PA20, PA15, PA10 and Sokalan CP10 by BASF GmbH, and those sold under the tradename Acusol 45N, 480N, 460N by Rohm and Haas. Preferred acrylic acid containing copolymers include those which contain as monomer units: a) from 90% to 10%, preferably from 80% to 20% by weight acrylic acid or its salts and b) from 10% to 90%, preferably from 20% to 80% by weight of a substituted acrylic monomer or its salts having the general formula —[CR₂—CR₁(CO—O—R₃)]— wherein at least one of the substituents R₁, R₂ or R₃, preferably R₁ or R₂ is a 1 to 4 carbon alkyl or hydroxyalkyl group, R₁ or R₂ can be a hydrogen and R₃ can be a hydrogen or alkali metal salt. Most preferred is a substituted acrylic monomer wherein R₁ is methyl, R₂ is hydrogen (i.e. a methacrylic acid monomer). The most preferred copolymer of this type has a molecular weight of 3500 and contains 60% to 80% by weight of acrylic acid and 40% to 20% by weight of methacrylic acid.

Sulphonated polymers are suitable for use in the present invention. Preferred examples include copolymers of CH₂═CR¹—CR²R³—O—C₄H₃R⁴—SO₃X wherein R¹, R², R³, R⁴ are independently 1 to 6 carbon alkyl or hydrogen, and X is hydrogen or alkali with any suitable other monomer units including modified acrylic, fumaric, maleic, itaconic, aconitic, mesaconic, citraconic and methylenemalonic acid or their salts, maleic anhydride, acrylamide, alkylene, vinylmethyl ether, styrene and any mixtures thereof. Other suitable sulphonated monomers for incorporation in such copolymers are 2-acrylamido methyl-1-propanesulphonic acid, 2-methacrylamido-2-methyl-1-propanesulphonic acid, 3-methacrylamido-2-hydroxy-propanesulphonic acid, allysulphonic acid, methallysulphonic acid, 2-hydroxy-3-(2-propenyloxy)propanesulphonic acid, 2-methyl-2-propenen-1-sulphonic acid, styrenesulphonic acid, vinylsulphonic acid, 3-sulphopropyl acrylate, 3-sulphopropylmethacrylate, sulphomethylacrylamide, sulphomethylmethacrylamide and water soluble salts thereof.

The water soluble polymer may comprise a polyamine or a modified polyamine compound. Preferred examples include those derived from aspartic acid.

The water soluble polymer system may comprise a soil release agent. Examples of polymeric soil release agents include those having: (a) one or more nonionic hydrophile components consisting essentially of (i) polyoxyethylene segments with a degree of polymerization of at least 2, or (ii) oxypropylene or polyoxypropylene segments with a degree of polymerization of from 2 to 10, wherein said hydrophile segment does not encompass any oxypropylene unit unless it is bonded to adjacent moieties at each end by ether linkages, or (iii) a mixture of oxyalkylene units comprising oxyethylene and from 1 to 30 oxypropylene units, said hydrophile segments preferably comprising at least 25% oxyethylene units and more preferably, especially for such components having 20 to 30 oxypropylene units, at least 50% oxyethylene units; or (b) one or more hydrophobe components comprising (i) C₃ oxyalkylene terephthalate segments, wherein, if said hydrophobe components also comprise oxyethylene terephthalate, the ratio of oxyethylene terephthalate:C₃ oxyalkylene terephthalate units is 2:1 or lower, (ii) C₄-C₆ alkylene or oxy C₄-C₆ alkylene segments, or mixtures therein, (iii) poly(vinyl ester) segments, preferably polyvinyl acetate, having a degree of polymerization of at least 2, or (iv) C₁-C₄ alkyl ether or C₄ hydroxyalkyl ether substituents, or mixtures therein, wherein said substituents are present in the form of C₁-C₄ alkyl ether or C₄ hydroxyalkyl ether cellulose derivatives, or mixtures therein, or a combination of (a) and (b). Typically, the polyoxyethylene segments of (a)(i) will have a degree of polymerization of from 200, although higher levels can be used, preferably from 3 to 150, more preferably from 6 to 100. Suitable oxy C₄-C₆ alkylene hydrophobe segments include, but are not limited to, end-caps of polymeric soil release agents such as MO₃S(CH₂)ₙOCH₂CH₂O—, where M is sodium and n is an integer from 4-6. Other soil release agents useful herein also include cellulosic derivatives such as hydroxyether cellulosic polymers, copolymeric blocks of ethylene terephthalate or propylene terephthalate with polyethylene oxide or polypropylene oxide terephthalate, and the like. Such agents are commercially available and include hydroxyethers of cellulose such as METHOCEL (Dow). Cellulosic soil release agents for use herein also include those selected from the group consisting of C₁-C₄ alkyl and C₄ hydroxyalkyl cellulose. Further suitable surfactants include water-soluble cationic ethoxylated amine compounds with particulate soil/clay-soil removal and/or anti-redeposition properties. Particularly preferred of these cationic compounds are ethoxylated cationic monoamines, diamines or triamines.

The water soluble filler preferably comprises at least 10 wt % of the resin composition, more preferably at least 15 wt %, more preferably at least 20 wt %, more preferably at least 30 wt %, more preferably at least 40 wt % and most preferably at least 50 wt %.

The filler may comprise a carbohydrate. Carbohydrates are usually represented by the generalised formula Cₓ(H₂O)_{y}. The term herein also includes materials which are similar in nature like gluconic acids or amino sugars which cannot be fully represented by said formula. Also other carbohydrate derivatives like sugar alcohols such as sorbitol, glucitol, mannitol, galactitol, dulcitol, xylitol and erythritol and other derivatives such as isomaltutose and isomalt can be used in the present invention.

Preferred monosaccharides for use in the invention include glucose, dextrose and fructose.

Preferred oligosaccharides for use in the invention include lactose, sucrose, maltose and dextrins.

Preferred polysaccharides for use in the invention include water soluble starch derivatives and water soluble cellulose materials. These substances can be very similar in nature to the water soluble polymers proposed. However, not all polysaccharides are materials possessing good film forming properties. These materials are much more suitable as the water-soluble filler. Such materials include pregelatinized starch and cellulose materials. Pregelatinized starch means starch which has been processed in the presence of water to rupture most of the starch granules and then dried for improved water solubility. Cellulose materials will be mostly chemically modified materials like methyl-, ethyl-, hydroxyethy-hydroxypropylcellulose ethers, and carboxymethyl cellulose and/or mixtures thereof. The filler may comprise an ionic sulphate salt. Preferred example of sulphate salts include alkali metal salts. Sodium sulphate is especially preferred.

The filler may comprise an ionic silicate. A preferred example of a silicate is an alkali metal silicate, such as sodium silicate having an SiO₂:Na₂O ratio of from 1.8 to 3.0, preferably from 1.8 to 2.4, most preferably 2.0. The sodium silicate may be in the form of either the anhydrous salt or a hydrated salt. The alkali metal silicate may be present as a component of an alkalinity system. The alkalinity system preferably further contains sodium metasilicate, present at a level of at least 0.4% SiO₂ by weight. The weight ratio of sodium silicate to said sodium metasilicate, measured in terms of SiO₂, is preferably from 50:1 to 5:4, more preferably from 15:1 to 2:1, most preferably from 10:1 to 5:2.

The filler may comprise a builder/co-builder.

By co-builder it is meant a compound which acts in addition to a builder compound to sequester (chelate) heavy metal ions. These components may also have calcium and magnesium chelation capacity, but preferentially they show selectivity to binding heavy metal ions such as iron, manganese and copper. Co-builders, which are typically acidic, having for example phosphonic acid or carboxylic acid functionalities, may be present either in their acid form or as a complex/salt with a suitable counter cation such as an alkali or alkaline metal ion, ammonium, or substituted ammonium ion, or any mixtures thereof. The molar ratio of said counter cation to the co-builder is preferably at least 1:1. Suitable co-builders for use herein include organic phosphonates, such as the amino alkylene poly(alkylene phosphonates), alkali metal ethane 1-hydroxy disphosphonates and nitrilo trimethylene phosphonates. Preferred among the above species are diethylene triamine penta(methylene phosphonate), ethylene diamine tri(methylene phosphonate)hexamethylene diamine tetra(methylene phosphonate) and hydroxy-ethylene 1,1 diphosphonate. Other suitable co-builders for use herein include nitrilotriacetic acid and polyaminocarboxylic acids such as ethylenediaminotetracetic acid, ethylenetriamine pentacetic acid, ethylenediamine disuccinic acid, ethylenediamine diglutaric acid, 2-hydroxypropylenediamine disuccinic acid or any salts thereof. Especially preferred is ethylenediamine-N,N′-disuccinic acid (EDDS) or the alkali metal, alkaline earth metal, ammonium, or substituted ammonium salts thereof, or mixtures thereof. Preferred EDDS compounds are the free acid form and the sodium or magnesium salt or complex thereof.

Suitable water-soluble builder compounds include the water soluble carboxylates or their acid forms, homo or copolymeric polycarboxylic acids or their salts in which the polycarboxylic acid comprises at least two carboxylic radicals separated from each other by not more than two carbon atoms, carbonates, bicarbonates, borates, phosphates, and mixtures of any of the foregoing. The carboxylate or polycarboxylate builder can be monomeric or oligomeric in type although monomeric polycarboxylates are generally preferred for reasons of cost and performance. Suitable carboxylates containing one carboxy group include the water soluble salts of lactic acid, glycolic acid and ether derivatives thereof. Suitable polycarboxylates containing two carboxy groups include the water-soluble salts of succinic acid, malonic acid, (ethylenedioxy) diacetic acid, maleic acid, diglycolic acid, tartaric acid, tartronic acid and fumaric acid, as well as the ether carboxylates and the sulphinyl carboxylates. Suitable polycarboxylates containing three carboxy groups include, in particular, water-soluble citrates, aconitrates and citraconates as well as succinate derivatives, lactoxysuccinates, and aminosuccinates, and the oxypolycarboxylate materials such as 2-oxa-1,1,3-propane tricarboxylates. Polycarboxylates containing four carboxy groups include oxydisuccinates, 1,1,2,2-ethane tetracarboxylates, 1,1,3,3-propane tetracarboxylates and 1,1,2,3-propane tetracarboxylates. Suitable polycarboxylates containing sulphur substituents include the sulphosuccinate derivatives, and the sulphonated pyrolysed citrates. Suitable alicyclic and heterocyclic polycarboxylates include cyclopentane-cis,cis,cis-tetracarboxylates, cyclopentadienide pentacarboxylates, 2,3,4,5-tetrahydrofuran-cis,cis,cis-tetracarboxylates, 2,5-tetrahydrofuran-cis-dicarboxylates, 2,2,5,5-tetrahydrofuran-tetracarboxylates, 1,2,3,4,5,6-hexane-hexacarboxylates and carboxymethyl derivatives of polyhydric alcohols such as sorbitol, mannitol and xylitol. Suitable aromatic polycarboxylates include mellitic acid, pyromellitic acid and the phthalic acid derivatives. Of the above, the preferred polycarboxylates are hydroxycarboxylates containing up to three carboxy groups per molecule, more particularly citrates. The parent acids of the monomeric or oligomeric polycarboxylate chelating agents or mixtures thereof with their salts, e.g. citric acid or citrate/citric acid mixtures are also contemplated as useful builder components. Borate builders, as well as builders containing borate-forming materials that can produce borate under detergent storage or wash conditions can also be used. Examples of suitable carbonate builders are the alkaline earth and alkali metal carbonates, preferably the sodium and potassium salts, including sodium carbonate and sesqui-carbonate and mixtures thereof with ultra-fine calcium carbonate. Highly preferred builder compounds for use in the present invention are water-soluble phosphate builders. Specific examples of water-soluble phosphate builders are the alkali metal tripolyphosphates, sodium, potassium and ammonium pyrophosphate, sodium and potassium and ammonium pyrophosphate, sodium and potassium orthophosphate, sodium polymeta/phosphate in which the degree of polymerisation preferably ranges from 6 to 21, and salts of phytic acid. Specific examples of suitable water-soluble phosphate builders are the alkali metal tripolyphosphates, sodium and potassium and ammonium pyrophosphate, sodium and potassium orthophosphate, sodium polymetaphosphate in which the degree of polymerization preferably ranges from 6 to 21, and salts of phytic acid.

Although less preferred the resin may also further comprise partially water soluble or insoluble builder compounds, i.e. in addition to a water soluble/water dispersible builder. Partially soluble and insoluble builder compounds are particularly suitable for disruption of the resin upon dissolution. Examples of partially water soluble builders include the crystalline layered silicates. Preferred are the crystalline layered sodium silicates. Crystalline layered sodium silicates of this type preferably have a two dimensional ‘sheet’ structure, such as the so called 8-layered structure. Further examples of largely water insoluble builders include the sodium aluminosilicates. Suitable aluminosilicates include the aluminosilicate zeolites.

The filler may comprise a crystal growth inhibitor. Suitable types of crystal growth inhibitors include organodiphosphonic acids. The organo diphosphonic acid is preferably a C₁-C₄ diphosphonic acid, more preferably a C₂ diphosphonic acid, such as ethylene diphosphonic acid, or most preferably ethane 1-hydroxy-1,1-diphosphonic acid (HEDP) and may be present in partially or fully ionized form, particularly as a salt or complex.

The filler may comprise a surfactant. Suitable surfactants are selected from anionic, cationic, ampholytic and zwitterionic surfactants and mixtures thereof. If the resin is for use in packaging of automatic dishwashing machine products the surfactant is preferably low foaming in character. To achieve this aim the surfactant system for use in dishwashing methods may be suppressed. Sudsing caused by surfactant systems used in laundry cleaning methods need not be suppressed to the same extent as is necessary for dishwashing.

A preferred resin in accordance with the invention meets one or more of the following physical parameters:
a) Melting point in the range of 180-220° C.
b) Glass transition temperature in the range of 50 to 60° C.
c) Good moulding properties, namely suitable for; hot runners, high speed, high cavitation, thin wall moulding (minimum wall thickness of around 0.5 mm).
d) Good flow-ability, namely having; a MFI range of 15 to 20 g/10 min at 210° C., no brittleness at ejection from mould, dimensional stability after moulding and high ductility.
e) High suitability for packaged materials (e.g. detergents) such as providing an effective barrier to the materials packaged therein and displaying compatibility with hygroscopic and caustic materials.
f) High solubility in water, for example a 3-5 g container comprising the resin of the invention dissolves within 20 minutes in a 1 L beaker of water at 40° C. when stirred at 200 r.p.m and within 30 minutes at 20° C. under the same conditions.

To meet these properties the resin may include a rheology modifying additive. Preferred examples of such additives include lubricants and plasticisers.

In this regard it will be appreciated that the additives are substantially water-soluble so that the overall resin retains its water solubility/water dispersibility.

Preferably the plasticiser content of the resin is less than 10 wt %, most preferrably less than 5%.

Suitable types of plasticisers include solvents.

Preferred examples of solvents include alkylene glycol mono lower alkyl ethers, glycerol, propylene glycols, ethoxylated or propoxylated ethylene or propylene, glycerol esters, glycerol triacetate, lower molecular weight polyethylene glycols, lower molecular weight methyl esters and amides. A preferred type of surfactant for use herein comprises the mono-, di-, tri-, or tetra-C₂-C₃ alkylene glycol mono C₂-C₆ alkyl ethers. Specific examples of such compounds include diethylene glycol monobutyl ether, tetraethylene glycol monobutyl ether, dipropylene glycol monoethyl ether, and dipropylene glycol monobutyl ether. Diethylene glycol mono butyl ether and dipropylene glycol monobutyl ether are especially preferred. Compounds of the type have been commercially marketed under the tradenames Dowanol, Carbitol, and Cellosolve. Another preferred type of surfactant comprises the lower molecular weight polyethylene glycols (PEGs). Such materials preferrably have molecular weights of at least 150. PEGs of molecular weight ranging from 200 to 600 are most preferred. Yet another preferred type of surfactant comprises lower molecular weight methyl esters. Such materials are those of the general formula: R—C(O)—OCH₃ wherein R ranges from 1 to 18. Examples of suitable lower molecular weight methyl esters include methyl acetate, methyl propionate, methyl octanoate, and methyl dodecanoate.

Suitable types of plasticisers also include nonionic surfactants.

Preferred nonionic surfactants incorporated into the resin provide a suds suppression benefit. The alkyl ethoxylate condensation products of an alcohol with from 1 to 80 moles of an alkylene (liner/branched aliphatic/aromatic optionally subsituted C₂ to C₂₀ alkylene) oxide are suitable for this use. The alkyl chain of the alcohol can either be straight or branched, primary or secondary, and generally contains from 6 to 22 carbon atoms. Particularly preferred are the condensation products of alcohols having an alkyl group containing from 8 to 20 carbon atoms with from 2 to 10 moles of ethylene oxide per mole of alcohol. In this regard Suitable surfactants include POLY-TERGENT(R) SLF-18B nonionic surfactants by Olin Corporation.

Ethoxylated C₆-C₁₈ fatty alcohols and C₆-C₁₈ mixed ethoxylated/propoxylated fatty alcohols are suitable surfactants for use herein. Preferably the ethoxylated fatty alcohols are the C₁₀-C₁₈ ethoxylated fatty alcohols with a degree of ethoxylation of from 3 to 50, most preferably these are the C₁₂-C₁₈ ethoxylated fatty alcohols with a degree of ethoxylation from 3 to 40. Preferably the mixed ethoxylated/propoxylated fatty alcohols have an alkyl chain length of from 10 to 18 carbon atoms, a degree of ethoxylation of from 3 to 30 and a degree of propoxylation of from 1 to 10.

The condensation products of ethylene oxide with a hydrophobic base formed by the condensation of propylene oxide with propylene glycol are suitable for use herein. The hydrophobic portion of these compounds preferably has a molecular weight of from 1500 to 1800 and exhibits water insolubility. Examples of compounds of this type include certain of the commercially-available Pluronic™ surfactants, marketed by BASF.

The condensation products of ethylene oxide with the product resulting from the reaction of propylene oxide and ethylenediamine are suitable for use herein. The hydrophobic moiety of these products consists of the reaction product of ethylenediamine and excess propylene oxide, and generally has a molecular weight of from 2500 to 3000. Examples of this type of nonionic surfactant include certain of the commercially available Tetronic™ compounds, marketed by BASF.

In a preferred embodiment of the present invention the resin comprises a mixed nonionic surfactant system.

Suitable lubricants include fatty esters of mono- or polyhydric alcohols having from 1 to 40 carbon atoms in the hydrocarbon chain. The fatty acid portion of the fatty ester can be obtained from mono- or poly-carboxylic acids having from 1 to 40 carbon atoms in the hydrocarbon chain. Suitable examples of monocarboxylic fatty acids include behenic acid, stearic acid, oleic acid, palmitic acid, myristic acid, lauric acid, acetic acid, propionic acid, butyric acid, isobutyric acid, valeric acid, lactic acid, glycolic acid and beta,beta′-dihydroxyisobutyric acid. Examples of suitable polycarboxylic acids include: n-butyl-malonic acid, isocitric acid, citric acid, maleic acid, malic acid and succinic acid. The fatty alcohol radical in the fatty ester can be represented by mono- or polyhydric alcohols having from 1 to 40 carbon atoms in the hydrocarbon chain. Examples of suitable fatty alcohols include; behenyl, arachidyl, cocoyl, oleyl and lauryl alcohol, ethylene glycol, glycerol, ethanol, isopropanol, vinyl alcohol, diglycerol, xylitol, sucrose, erythritol, pentaerythritol, sorbitol or sorbitan. Preferably, the fatty acid and/or fatty alcohol group of the fatty ester adjunct material has from 1 to 24 carbon atoms in the alkyl chain. Preferred fatty esters herein are ethylene glycol, glycerol and sorbitan esters wherein the fatty acid portion of the ester normally comprises a species selected from behenic acid, stearic acid, oleic acid, palmitic acid or myristic acid. The glycerol esters are also highly preferred. Specific examples of fatty alcohol esters for use herein include: stearyl acetate, palmityl di-lactate, cocoyl isobutyrate, oleyl maleate, oleyl dimaleate, and tallowyl proprionate. Fatty acid esters useful herein include: xylitol monopalmitate, pentaerythritol monostearate, sucrose monostearate, glycerol monostearate, ethylene glycol monostearate, sorbitan esters. Suitable sorbitan esters include sorbitan monostearate, sorbitan palmitate, sorbitan monolaurate, sorbitan monomyristate, sorbitan monobehenate, sorbitan mono-oleate, sorbitan dilaurate, sorbitan distearate, sorbitan dibehenate, sorbitan dioleate, and also mixed tallowalkyl sorbitan mono- and di-esters. Glycerol monostearate, glycerol mono-oleate, glycerol monopalmitate, glycerol monobehenate, and glycerol distearate are preferred glycerol esters herein. Further suitable agents include triglycerides, mono or diglycerides, and wholly or partially hydrogenated derivatives thereof, and any mixtures thereof. Suitable sources of fatty acid esters include vegetable and fish oils and animal fats. Suitable vegetable oils include soy bean oil, cotton seed oil, castor oil, olive oil, peanut oil, safflower oil, sunflower oil, rapeseed oil, grapeseed oil, palm oil and corn oil.

Waxes, including microcrystalline waxes are possible lubricants, although much less preferred in the present invention due to their poor solubility in water. Preferred waxes have a melting point in the range from 35° C. to 110° C. and comprise generally from 12 to 70 carbon atoms. Preferred are petroleum waxes of the paraffin and microcrystalline type which are composed of long-chain saturated hydrocarbon compounds.

The resin may include a colourant. Colourant when present as a component in the resin is preferably present at a level of from 0.001 wt % to 1.5 wt %, preferably from 0.01 wt % to 1.0 wt %, most preferably from 0.1 wt % to 0.3 wt %.

The colourant may comprise a dye or a pigment. Examples of suitable dyes include reactive dyes, direct dyes, azo dyes. Preferred dyes include phthalocyanine dyes, anthraquinone dye, quinoline dyes, monoazo, disazo and polyazo. More preferred dyes include anthraquinone, quinoline and monoazo dyes. Preferred dyes include SANDOLAN E-HRL 180% (tradename), SANDOLAN MILLING BLUE (tradename), TURQUOISE ACID BLUE (tradename) and SANDOLAN BRILLIANT GREEN (tradename) all available from Clariant UK, HEXACOL QUINOLINE YELLOW (tradename) and HEXACOL BRILLIANT BLUE (tradename) both available from Pointings, UK, ULTRA MARINE BLUE (tradename) available from Holliday or LEVAFIX TURQUISE BLUE EBA (tradename) available from Bayer, USA.

The article preferably comprises a cleaning composition. The cleaning composition may be an automatic dishwashing detergent or additive, a laundry detergent or additive, a hard surface cleaning composition (such as an all-purpose-cleaner) or a toilet reservoir cleaner.

When used in a dishwasher application the article has been found to be particularly suitable since the packaging resin is formed of two highly water soluble components; a water soluble polymer and a water soluble filler; in use the article has been found to overcome the problem of residue formation on items being cleaned, said residue being formed of packaging material having poor solubility.

The cleaning composition may be a powder or a liquid, but if a liquid, is preferably a low water formulation, preferably having a maximum water content of 5 wt %, in order to maintain the integrity of the article. It will be appreciated that a higher water content may be present where the water is chemically or physically bound (i.e. by a high ionic strength solution).

The cleaning composition is preferably based around a surfactant, which may be anionic, cationic, zwitterionic or non-ionic. The composition may further comprise an additive of the type normally found in cleaning compositions. Preferred examples of such an additive include a builder, a bleach, an enzyme, a viscosity modifier, a perfume, a colourant, an acidity modifier and a bactericide/fungicide.

The composition may be formulated having regard to the fact that the user will not come into contact with the composition, whether by inhalation or by skin contact. For example, the composition may include an enzyme, without concern about physical contact between the composition containing the enzyme, and the user.

According to a second aspect of the present invention there is provided a method of producing an article having a water-soluble skin, wherein the skin is formed in an injection moulding process using a water soluble resin which comprises a water-soluble polymer and a water-soluble filler.

Injection moulding techniques are well known to the skilled person and are well described in the literature (see, for example a good summary is provided in “The Wiley Encyclopedia of Packaging Technology” Wiley Interscience 1986). Special techniques, described below, are preferred features of the invention for producing containers having more than one type of polymer.

Simultaneous Injection Moulding

1) two or more polymers are molten mixed and injected into a mould;
2) two or more polymers are injected into a mould through more than one gate, each gate allowing simultaneous injection of a single polymer or molten mix into the mould;
3) simultaneously injection moulding two or more compartments and then joining the compartments together.
   Sequential Injection Moulding
1) multi-component injection moulding;
2) sandwich injection moulding;
3) sequentially injection moulding two or more;
4) compartments and then joining the compartments together.

Multi-component injection moulding covers two distinct processes.
A) injection moulding a polymer or molten polymer mix into a mould, removing the solid polymer and inserting it into a second mould and injection moulding a second polymer or polymer mix into the second mould;
B) injection moulding a polymer or molten polymer mix into a part of a mould, injection moulding a second polymer or molten polymer mix into a further part of the mould.

Steps A) and B) may be repeated more than once and may be combined. It will be appreciated by the skilled person that the first injection moulded polymer must survive the pressure and temperature conditions of the second, or subsequent, injection moulding.

For step B) the first polymer or molten mix may be prevented from entering parts of the mould by any physical means, such as, gates, gravity, positive or negative pressure.

Sandwich injection moulding (or sometimes called skin-core injection moulding) comprises injection moulding a polymer or molten polymer mix into a mould until it is partially filled and then injecting a second polymer or molten polymer mix into the same mould through the same gate to form the core. An additional step of sealing the core may be performed.

It will be appreciated that any combination of simultaneous and sequential injection moulding may be used.

1. An article comprising a skin formed from a water soluble resin, wherein the resin comprises a water-soluble polymer and a water-soluble filler.

2. An article claim 1 wherein the water soluble polymer preferably comprises 20-90 wt % of the resin.

3. An article according to claim 1 wherein the water soluble polymer comprises a film forming polymer.

4. An article according to claim 1, wherein the water soluble polymer comprises a polymer selected from: polyvinyl alcohol, polyvinyl pyrrolidone, partially hydrolysed polyvinyl acetate, polyvinyl acetate, a cellulose polymer, hydroxypropyl cellulose as well as copolymers containing said polymers, derivatives of said polymers, or a mixture thereof.

5. An article according to claim 1 wherein the water soluble polymer comprises a polymeric polycarboxylic acid, a polycarboxylate or a salt thereof.

6. An article according to claim 1, wherein the water soluble polymer comprises a sulphonated polymer.

7. An article according to claim 6, wherein the sulphonated polymer is based upon the monomer of Formula (1):
CH₂═CR¹—CR²R³—O—C₄H₃R⁴—SO₃X (1)
wherein R¹, R², R³, R⁴ are independently 1 to 6 carbon alkyl or hydrogen, and X is hydrogen or alkali; homopolymerised or copolymerised with one or more of acrylic, fumaric, maleic, itaconic, aconitic, mesaconic, citraconic and methylenemalonic acids or their salts, maleic anhydride, acrylamide, alkylene, vinylmethyl ether, styrene or a mixture thereof.

8. An article according to claim 1, wherein the water soluble polymer comprises a polyamine.

9. An article according to claim 1, wherein the water soluble filler comprises at least 10 wt % of the resin composition.

10. An article according to claim 1, wherein the water soluble filler comprises a carbohydrate.

11. An article according to claim 10, wherein the carbohydrate comprises glucose, dextrose, fructose, lactose, sucrose, maltose, a dextrin, a sugar alcohol, a water soluble starch derivative, a water soluble cellulose material or a mixture thereof.

12. An article according to claim 1, wherein the water soluble filler comprises an ionic sulphate salt.

13. An article according to claim 1, wherein the water soluble filler comprises an ionic silicate.

14. An article according to claim 1, wherein the water soluble filler comprises an oligomeric phosphate.

15. An article according to claim 1, wherein the water soluble filler has a detergent function.

16. An article according to claim 15, wherein the filler comprises a builder and/or a surfactant.

17. An article according to claim 1, wherein the resin includes a lubricant or a plasticiser.

18. An article comprising a skin formed from a water soluble resin and a detergent composition, wherein the resin is in accordance claim 1.

19. A method of producing an article having a water-soluble or water dispersible skin, wherein the skin is formed in an injection moulding process using a water soluble resin in accordance with claim 1.
